(19) United States
(12) Patent Application Publication
(10) Pub. No.: US 2011/0155723 A1
(43) Pub. Date: Jun. 30, 2011

(54) COIL FIXING MODULE AND INDUCTION COIL MODULE EMPLOYING THE SAME

(75) Inventors: Hsi-An Liu, Taoyuan Hsien (TW); Shih-Ming Yan, Taoyuan Hsien (TW)

(73) Assignee: DELTA ELECTRONICS, INC, Taoyuan Hsien (TW)

(21) Appl. No.: 12/977,046

(22) Filed: Dec. 22, 2010

(30) Foreign Application Priority Data
Dec. 24, 2009 (TW) 098144824

(51) Int. Cl. H05B 6/36; H01F 5/00

(52) U.S. Cl. 219/672; 335/299

(57) ABSTRACT

A coil fixing module is provided for fixing a coil of an electromagnetic device. The coil fixing module includes a supporting member and a fastening member. The supporting member is used for supporting the coil. The fastening member is disposed on the supporting member for clamping the coil between the supporting member and the fastening member, so that the coil is fixed with respect to the supporting member.

### CLAIM OF PRIORITY

This application claims priority to Taiwanese Patent Application No. 098144824 filed on Dec. 24, 2009.

### FIELD OF THE INVENTION

The present invention relates to a coil fixing structure, and more particularly to a coil fixing structure for use in an induction coil module of an electromagnetic device.

### BACKGROUND OF THE INVENTION

Nowadays, a variety of heating devices such as gas stoves, infrared oven, microwave oven and electric stove are widely used to cook food. For example, an induction cooking stove is widely used to cook food. When a current flows through an induction coil of the induction cooking stove, electromagnetic induction is performed to produce eddy current, thereby heating a foodstuff container.

For fabricating the induction coil of an induction cooking stove, a conductive wire is firstly wound into a disk-like coil by a jig tool. Then, the coil is initially fixed via an adhesive. Then, the coil is removed from the jig tool, and attached on a supporting element via an adhesive.

Generally, dispensing equipment is used to apply the adhesive. After the adhesive is applied, a drying machine is used to dry the adhesive. In other words, the conventional process of fixing the coil is time-consuming, complicated and costly. In addition, if the adhesive is improperly applied, the efficacy of fixing the coil is deteriorated, and the related machines are possibly contaminated. The quality of the adhesive may influence the reliability of the final product when the final product is used in a high temperature environment. If the quality of the adhesive is undesirable, the overall performance of the final product is reduced.

Therefore, there is a need of providing a coil fixing structure so as to obviate the drawbacks encountered from the prior art.

### SUMMARY OF THE INVENTION

It is an object of the present invention to provide a coil fixing structure for fixing a coil without need of using an adhesive in order to simply the process of fixing the coil.

In accordance with an aspect of the present invention, there is provided a coil fixing module for fixing a coil of an electromagnetic device. The coil fixing module includes a supporting member and a fastening member. The supporting member is used for supporting the coil. The fastening member is disposed on the supporting member for clamping the coil between the supporting member and the fastening member, so that the coil is fixed with respect to the supporting member.

In accordance with another aspect of the present invention, there is provided an induction coil module of an electromagnetic device. The induction coil module includes a supporting member, a coil, a fastening member and a magnetic core assembly. The supporting member has a first surface and a second surface. The coil is supported on the first surface of the supporting member. The fastening member is used for fixing the coil on the first surface of the supporting member. The magnetic core assembly is disposed on the second surface of the supporting member.

The above contents of the present invention will become more readily apparent to those ordinarily skilled in the art after reviewing the following detailed description and accompanying drawings, in which:

### BRIEF DESCRIPTION OF THE DRAWINGS

FIG. 1A is a schematic front view illustrating an induction coil module according to a first embodiment of the present invention;

FIG. 1B is a schematic rear view illustrating the induction coil module of FIG. 1A;

FIG. 1C is a schematic perspective view illustrating the supporting member of the coil fixing module as shown in FIGS. 1A and 1B;

FIG. 1D is a schematic perspective view illustrating the fastening member of the coil fixing module as shown in FIGS. 1A and 1B;

FIG. 2A is a schematic front view illustrating an induction coil module according to a second embodiment of the present invention;

FIG. 2B is a schematic perspective view illustrating the fastening member of the coil fixing module as shown in FIG. 2A;

FIG. 3 is a schematic front view illustrating an induction coil module according to a third embodiment of the present invention;

FIG. 4 is a schematic front view illustrating an induction coil module according to a fourth embodiment of the present invention;

FIG. 5A is a schematic front view illustrating an induction coil module according to a fifth embodiment of the present invention;

FIG. 5B is a schematic rear view illustrating the induction coil module of FIG. 5A; and

FIG. 5C is a schematic cross-sectional view illustrating the induction coil module of FIG. 5A taken along the line a-a′.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

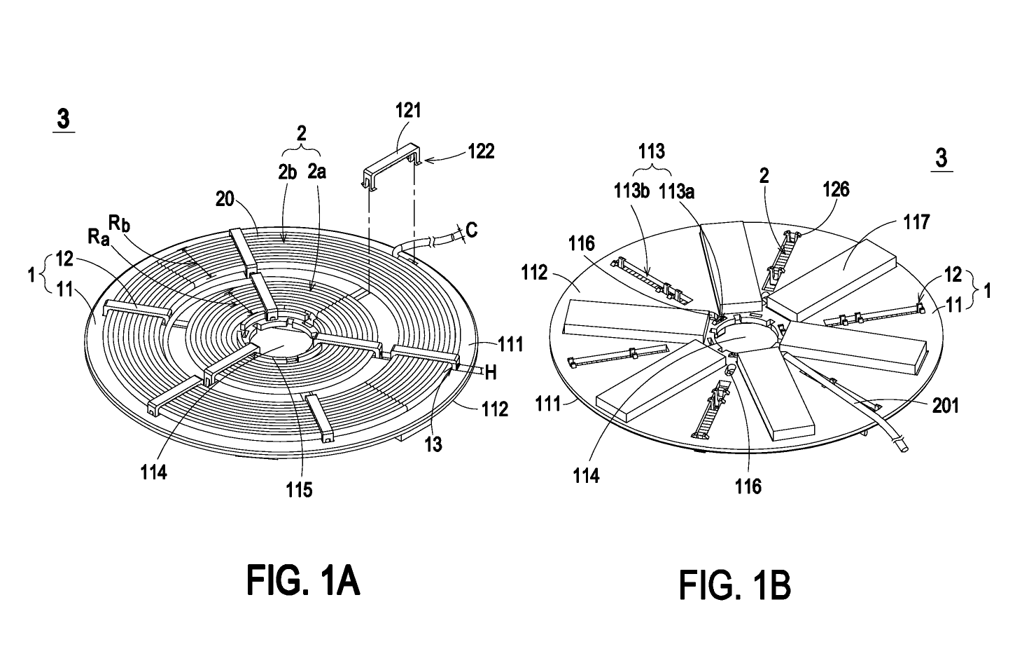

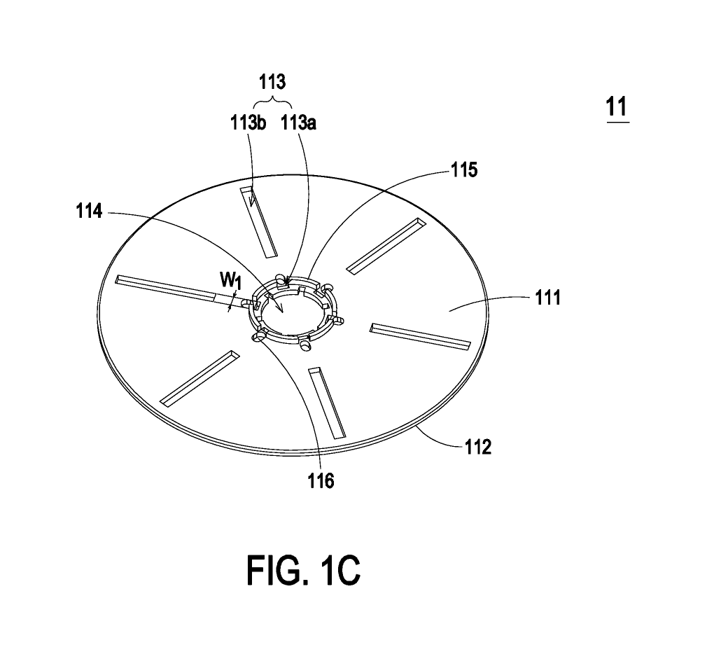

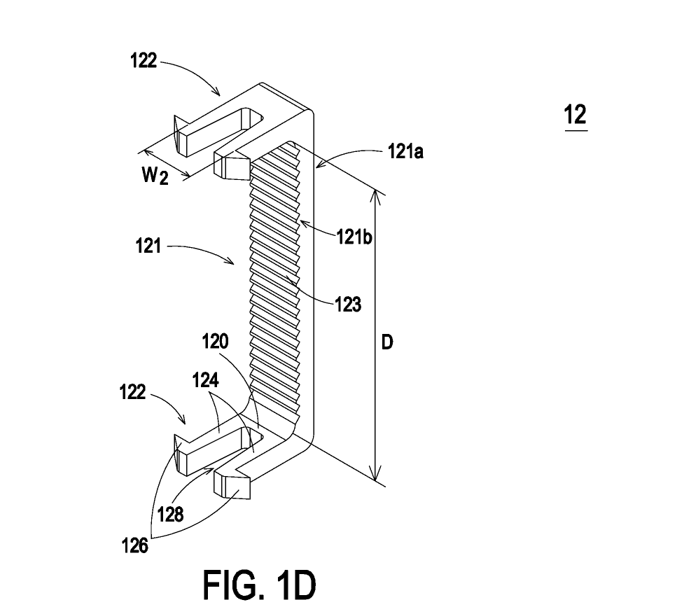

FIG. 1A is a schematic front view illustrating an induction coil module according to a first embodiment of the present invention. FIG. 1B is a schematic rear view illustrating the induction coil module of FIG. 1A. Please refer to FIGS. 1A and 1B. The induction coil module 3 is applied to an electromagnetic device such as an induction cooking stove. The induction coil module 3 comprises a coil fixing module 1 and a coil 2. The coil fixing module 1 is used for fixing the coil 2. The coil fixing module 1 comprises a supporting member 11 and a fastening member 12. The coil 2 is supported on the supporting member 11. The fastening member 12 is disposed on the supporting member 11. By means of the supporting member 11 and the fastening member 12, the coil 2 is clamped between the supporting member 11 and the fastening member 12, so that the coil 2 is fixed with respect to the supporting member 11.

FIG. 1C is a schematic perspective view illustrating the supporting member of the coil fixing module as shown in FIGS. 1A and 1B. The supporting member 11 has a first surface 111 and a second surface 112, wherein the first surface 111 and the second surface 112 are opposed to each other. The coil 2 is supported on the first surface 111 (see FIG. 1A). In addition, the supporting member 11 further comprises at least a groove 113, a middle opening 114, at least a protruding edge 115 and at least a perforation 116. The middle opening 114 runs through the supporting member 11 in the direction perpendicular to the first surface 111 and the second surface 112. In this embodiment, the supporting member 11 is a circular disk. The middle opening 114 is substantially at a geometric center (e.g. a center of a circle) of the supporting member 11. The middle opening 114 has a circular shape. The diameter of the middle opening 114 is fitted with the spindle of a jig tool (not shown), so that the supporting member 11 can be sheathed around the jig tool for facilitating installing the coil 2. The protruding edge 115 is disposed on the first surface 111 of the supporting member 11 and arranged near the periphery of the middle opening 114. As such, the protruding edge 115 is slightly protruded over the first surface 111.

Please refer to FIG. 1C again. In this embodiment, the supporting member 11 comprises plural grooves 113 (e.g. six grooves). The number of the grooves may be varied according to the dimension of the supporting member 11. These grooves 113 run through the supporting member 11. In additions, the grooves 113 are radially arranged in the supporting member 11 and enclose the middle opening 114.

Moreover, a magnetic core assembly 117 of the electromagnetic device is disposed on the second surface 112 of the supporting member 11, and arranged between any two adjacent grooves 113 (see FIG. 1B). For electric safety, the groove 113 comprises a first groove portion 113a and a second groove portion 113b, which are separated from each other. The first groove portion 113a is closer to the protruding edge 115 than the second groove portion 113b. The first groove portion 113a and the second groove portion 113b are substantially arranged in the same line. The first groove portion 113a and the second groove portion 113b have the same width W.

The perforation 116 runs through the supporting member 11. The perforation 116 is arranged in the vicinity of the protruding edge 115. In this embodiment, the supporting member 11 comprises plural perforations 116 (e.g. six perforations). The number of the perforations 116 may be varied according to the dimension of the supporting member 11. An output terminal 201 of the coil 2 may be penetrated through any of the perforations 116.

Since the coil fixing module 1 is applied to an electromagnetic device such as an induction cooking stove, the supporting member 11 of the coil fixing module 1 should withstand high temperature. For example, the supporting member 11 is made of high temperature-resistant material. It is preferred that the supporting member 11 is made of high temperature-resistant, insulated and nonmagnetic material, e.g. a composite material of polyphenylene sulfide (PPS) or poly(butylene terephthalate) (PBT) and glass fiber.

FIG. 1D is a schematic perspective view illustrating the fastening member of the coil fixing module as shown in FIGS. 1A and 1B. The fastening member 12 comprises a pressing part 121 and an engaging part 122. The pressing part 121 is substantially a rectangular slice having a first sidewall 121a and a second sidewall 121b. The first sidewall 121a and the second sidewall 121b are opposed to each other. When the fastening member 12 is mounted on the supporting member 11, the second sidewall 121b is in contact with the coil 2 (see FIG. 1A). Moreover, the second sidewall 121b has a saw-toothed profile 123 for facilitating pressing the coil 2. The first sidewall 121a may have a flat profile or any other profile. The engaging part 122 is connected with the pressing part 121. In this embodiment, two engaging parts 122 are extended from two distal ends of the pressing part 121. As such, the fastening member 12 is substantially U-shaped. For complying with the coil 2 that is supported on the supporting member 11, the two engaging parts 122 are separated from each other by an engaging part spacing interval D. The engaging part 122 comprises a connecting structure 120 and two extension legs 124. The two extension legs 124 are connected with the pressing part 121 through the connecting structure 120. An engaging part width W2 between the outer surfaces of these two extension legs 124 is equal to or slightly greater than the width W1 of the groove 113 of the supporting member 11. In addition, the engaging part 122 has a gap 128 between these two extension legs 124. The extension legs 124 have respective protruding blocks 126, which are externally protruded in the opposite directions. When the fastening member 12 is assembled with the supporting member 11, an external force may be applied on the outer surfaces of the extension legs 124. In response to the external force, the extension legs 124 are moved toward the gap 128 such that the engaging part 122 slightly deforms. After the protruding blocks 126 are penetrated through the groove 113, the external force is eliminated, and thus the protruding blocks 126 are sustained on the second surface 112 of the supporting member 11.

It is preferred that the pressing part 121 and the engaging part 122 of the fastening member 12 are integrally formed. Since the coil fixing module 1 is applied to an electromagnetic device such as an induction cooking stove, the fastening member 12 of the coil fixing module 1 should withstand high temperature. For example, the fastening member 12 is made of high temperature-resistant material. It is preferred that the fastening member 12 is made of high temperature-resistant and nonmagnetic material, e.g. aluminum or high temperature-resistant plastic. More preferably, the fastening member 12 is made of high temperature-resistant material, insulated and nonmagnetic material.

Hereinafter, a process of assembling the coil fixing module 1 and the coil 2 as the induction coil module 3 will be illustrated with reference to FIGS. 1A, 1B, 1C and 1D.

Firstly, the supporting member 11 is placed on a jig tool (not shown), wherein the middle opening 114 is sheathed around the spindle of the jig tool. Then, a terminal 201 of a conductive wire 20 of the coil 2 is penetrated through a perforation 116. The supporting member 11 is rotated by the jig tool such that the inner diameter of the coil 2 is fixed by the protruding edge 115. The conductive wire 20 is continuously wound on the first surface 111 of the supporting member 11, thereby forming the coil 2. In this embodiment, the coil 2 comprises an inner coil part 2a and an external coil part 2b. The width Ra of the inner coil part 2a is substantially equal to the width Rb of the external coil part 2b. The width Ra (or Rb) is equal to or slightly greater than the engaging part spacing interval D. Then, the inner coil part 2a and the external coil part 2b of the coil 2 are fixed by the fastening member 12.

Please refer to FIGS. 1A and 1B again. For example, a process of fixing the external coil part 2b by the fastening member 12 will be illustrated. The fastening member 12 is aligned with the groove 113. The pressing part 121 is substantially parallel with the first surface 111 of the supporting member 11. The engaging parts 122 are penetrated through the second groove portion 113b of the groove 113 in the direction vertical to the first surface 111 of the supporting member 11. During the engaging parts 122 are penetrated through the groove 113, an external force is applied on the outer surfaces of the extension legs 124. In response to the external force, the extension legs 124 are moved toward the gap 128 such that the engaging part 122 slightly deforms. After the protruding blocks 126 are penetrated through the groove 113, the external force is eliminated and the extension legs 124 restore to the original positions. Since the width W2 of the engaging part 122 is equal to or slightly greater than the width W1 of the groove 113, the extension legs 124 are partially accommodated within the groove 113 and the outer surfaces of the extension legs 124 are in contact with the inner walls of the second groove portion 113b. At the same time, the protruding blocks 126 are sustained on the second surface 112 of the supporting member 11 for preventing detachment of the fastening member 12 from the supporting member 11. For facilitating positioning the protruding blocks 126, several bulges or indentations (not shown) may be optionally formed in the second surface 112 of the supporting member 11.

After the fastening member 12 is assembled with the supporting member 11, a receptacle 13 is defined between the second sidewall 121b of the pressing part 121 and the first surface 111 of the supporting member 11. The height H of the receptacle 13 is substantially equal to the wire diameter C of the coil 2. That is, the pressing part 121 of the fastening member 12 is moved in the direction vertical to the first surface 111 of the supporting member 11 so as to press the coil 2. At the same time, the second sidewall 121b of the pressing part 121 is in contact with the coil 2. Due to the saw-toothed profile 123, the friction between the pressing part 121 and the coil 2 is increased, and thus the efficacy of pressing the coil 2 is enhanced. In this situation, the coil 2 lies flat on the first surface 111 of the supporting member 11. On the other hand, since the engaging part spacing interval D is equal to or slightly smaller than the width Rb of the external coil part 2b of the coil 2, the movable range of the external coil part 2b in the direction parallel with the first surface 111 of the supporting member 11 is confined by the engaging part 122 of the fastening member 12. By means of the supporting member 11 and the fastening member 12, the external coil part 2b of the coil 2 is clamped between the second sidewall 121b of the pressing part 121 and the first surface 111 of the supporting member 11. As a consequence, the external coil part 2b of the coil 2 is securely fixed in the predetermined position.

In this embodiment, the width Ra of the inner coil part 2a is substantially equal to the width Rb of the external coil part 2b. As such, the inner coil part 2a could be fixed by the fastening member 12 in the similar way. Moreover, the two engaging parts 122 of the fastening member 12 are respectively penetrated through the first groove portion 113a and the second groove portion 113b of the groove 113. Since the area of the inner coil part 2a is smaller than the external coil part 2b, the number of fastening members 12 for fixing the inner coil part 2a may be smaller than the number of fastening members 12 for fixing the external coil part 2b. For example, three fastening members 12 are used for fixing the inner coil part 2a, and six fastening members 12 are used for fixing the external coil part 2b. The process of fixing the inner coil part 2a by the supporting member 11 and the fastening member 12 is similar to the process of fixing the external coil part 2b, and is not redundantly described herein. After the inner coil part 2a and the external coil part 2b are positioned with respect to the supporting member 11, the supporting member 11 could be removed from the jig tool. The induction coil module 3 of the coil fixing module 1 and the coil 2 is shown in FIGS. 1A and 1B. By means of the supporting member 11 and the fastening member 12, the coil 2 is securely fixed on the first surface 111 of the supporting member 11.

From the above description, since no adhesive is necessary to fix the coil by the coil fixing module of the present invention, the drawbacks of using the adhesive are overcome. Moreover, after the conductive wire is wound as the coil 2, the coil 2 is fixed by the supporting member 11 and the fastening member 12 without difficulty. In other words, the process of producing the induction coil module of the present invention is very simple. Due to the perforations 116 of the supporting member 11, the inductance of the coil 2 may be precisely adjusted according to the turn number of the coil 2. In a case that the width Ra of the inner coil part 2a and/or the width Rb of the external coil part 2b is changed, the engaging part spacing interval D may be adjusted to fix the coil 2.

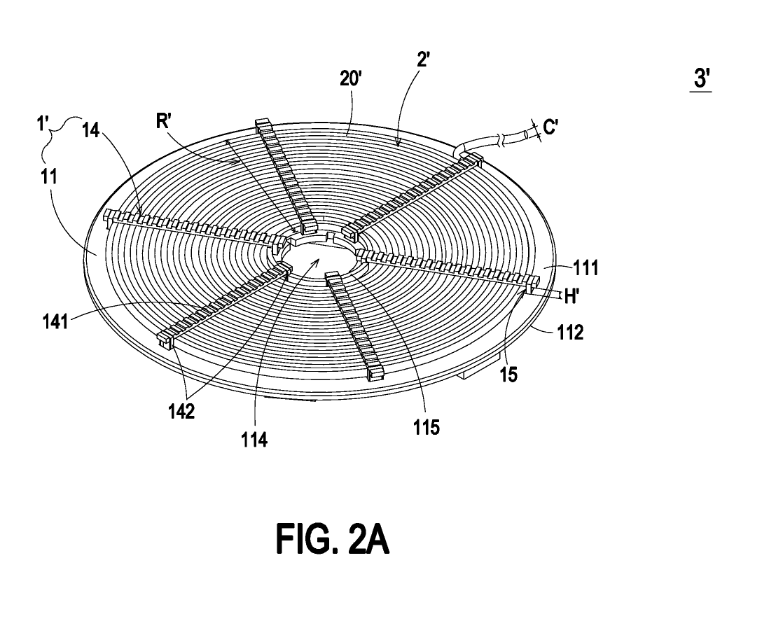

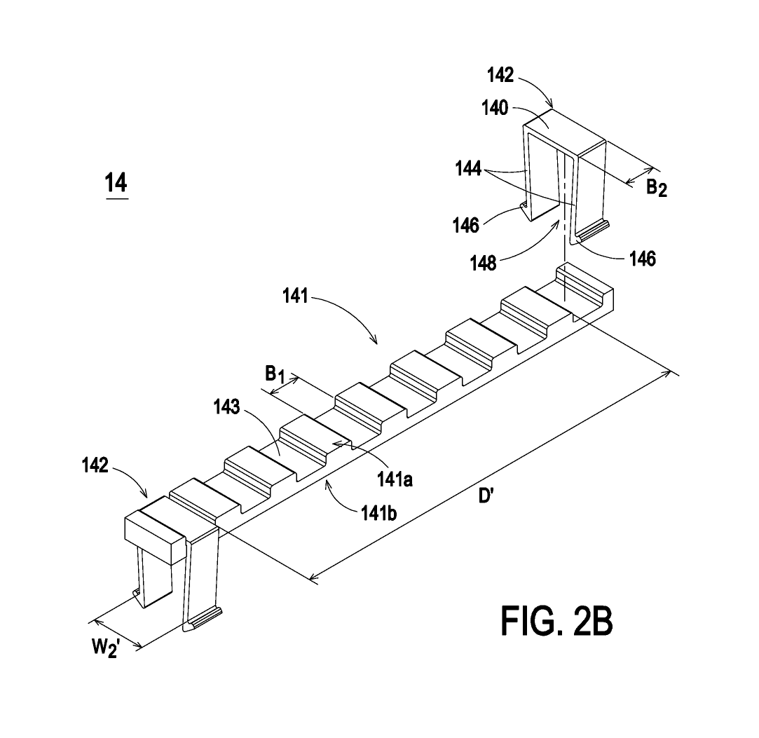

FIG. 2A is a schematic front view illustrating an induction coil module according to a second embodiment of the present invention. The induction coil module 3′ comprises a coil fixing module 1′ and a coil 2′. The coil fixing module 1′ comprises a supporting member 11 and a fastening member 14. The configurations of the supporting member 11 is identical to those shown in FIG. 1C, and are not redundantly described herein. The coil 2′ is supported on the first surface 111 of the supporting member 11. By means of the supporting member 11 and the fastening member 14, the coil 2′ is fixed with respect to the supporting member 11.

FIG. 2B is a schematic perspective view illustrating the fastening member of the coil fixing module as shown in FIG. 2A. The fastening member 14 comprises a pressing part 141 and an engaging part 142. The pressing part 141 is substantially a rectangular slice having a first sidewall 141a and a second sidewall 141b. The first sidewall 141a and the second sidewall 141b are opposed to each other. The length of the pressing part 141 is substantially equal to the width R′ of the coil 2′. In addition, several recesses 143 are formed in the first sidewall 141a. These recesses 143 are discretely arranged at regular spacing intervals. The width B1 of the recess 143 is substantially equal to the wire diameter C′ of the coil 2′. The engaging part 142 of the fastening member 14 comprises a connecting structure 140 and two extension legs 144. These two extension legs 144 are extended from both ends of the connecting structure 140. The width B2 of the connecting structure 140 is substantially equal to the width B1 of the recess 143. In addition, the engaging part 142 has a gap 148 between these two extension legs 144. The extension legs 144 have respective protruding blocks 146, which are externally protruded in the opposite directions. The functions of the gap 148 and the protruding blocks 146 are similar to those illustrated in FIGS. 1B and 1D, and are not redundantly described herein.

Please refer to FIG. 2B again. In this embodiment, the pressing part 141 and the engaging part 142 of the fastening member 14 are discrete components. For assembling the engaging part 142 with the pressing part 141, the connecting structure 140 of the engaging part 142 is firstly accommodated within a corresponding recess 143 of the pressing part 141, so that the extension legs 144 are protruded from two opposite edges of the pressing part 141. In other words, the two extension legs 144 are connected with the pressing part 141 through the connecting structure 140. Since the width B2 of the connecting structure 140 is substantially equal to the width B1 of the recess 143, the engaging part 142 could be securely fixed with respect to the pressing part 141. In this embodiment, the fastening member 14 comprises two engaging parts 142, which are disposed on both ends of the pressing part 141. Moreover, since the length of the pressing part 141 is substantially equal to the width R′ of the coil 2′, the two engaging parts 142 are separated from each other by an engaging part spacing interval D′ after the engaging part 142 is assembled with the pressing part 141. In other words, the engaging part spacing interval D′ is equal to or slightly smaller than the width R′ of the coil 2′. In addition, an engaging part width W2′ between the outer surfaces of these two extension legs 144 is equal to or slightly greater than the width W′ of the groove 113 of the supporting member 11.

Hereinafter, a process of assembling the coil fixing module 1′ and the coil 2′ as the induction coil module 3 will be illustrated with reference to FIGS. 2A and 2B.

Firstly, the supporting member 11 is placed on a jig tool (not shown), wherein the middle opening 114 is sheathed around the spindle of the jig tool. Then, a terminal of a conductive wire 20′ of the coil 2′ is penetrated through a perforation 116. The supporting member 11 is rotated by the jig tool such that the inner diameter of the coil 2′ is fixed by the protruding edge 115. The conductive wire 20′ is continuously wound on the first surface 111 of the supporting member 11, thereby forming the coil 2′. Then, the coil 2′ is pressed by the pressing part 141 of the fastening member 14. In this embodiment, the pressing part 141 is substantially parallel with the first surface 111 of the supporting member 11. The extension legs 144 of the engaging parts 142 are penetrated through and partially accommodated within the groove 113 of the supporting member 11. After the protruding blocks 146 are penetrated through the groove 113, the protruding blocks 146 are sustained on the second surface 112 of the supporting member. Since the engaging part spacing interval D′ is equal to or slightly smaller than the width R′ of the coil 2′, the coil 2′ could be securely fixed between the two engaging parts 142. In this situation, the possibility of detaching the coil 2′ from the first surface 111 of the supporting member 11 will be minimized. After the fastening member 14 is assembled with the supporting member 11, a receptacle 15 is defined between the second sidewall 141b of the pressing part 141 and the first surface 111 of the supporting member 11. The height H′ of the receptacle 15 is substantially equal to the wire diameter C′ of the coil 2′. As such, the second sidewall 141b of the pressing part 141 is in contact with the coil 2′ to press the coil 2′. In this situation, the coil 2′ lies flat on the first surface 111 of the supporting member 11.

In a case that the width R′ of the coil 2′ is changed, the length of the pressing part 141 is adjusted to comply with the width R′ of the coil 2′. Since the width B2 of the connecting structure 140 is substantially equal to the width B1 of the recess 143, the connecting structures 140 of the two engaging parts 142 may be accommodated within corresponding recesses 143 of the pressing part 141 according to the turn number (or width R′) of the coil 2′. In this situation, the coil 2′ could be confined between the two engaging parts 142 to tightly fix the coil 2′. Moreover, the second sidewall 141b of the pressing part 141 may have a saw-toothed profile for facilitating pressing the coil 2′ (see FIG. 1D). The first sidewall 141a may have a flat profile or any other profile.

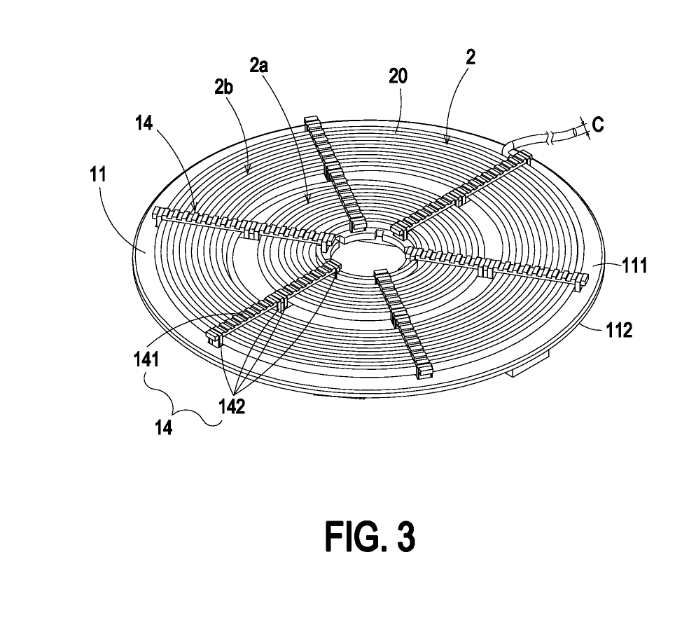

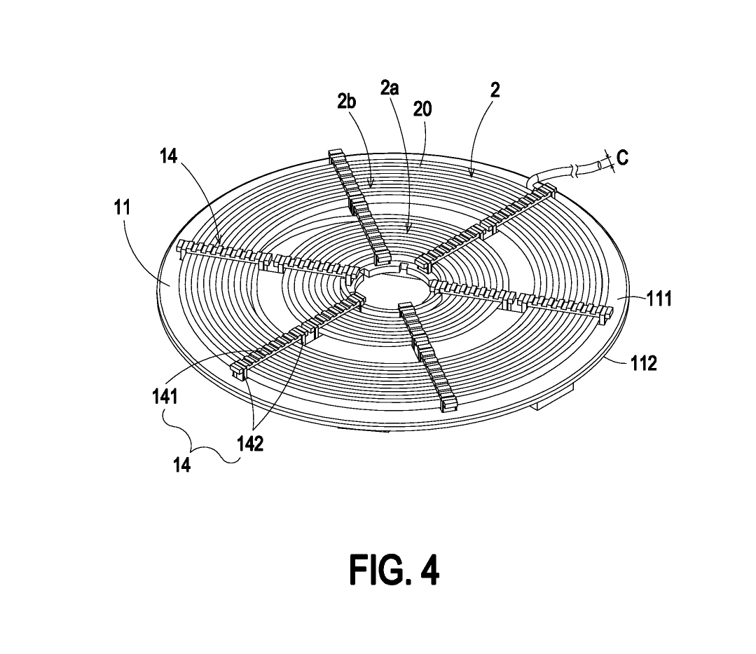

It is noted that, however, those skilled in the art will readily observe that numerous modifications and alterations may be made while retaining the teachings of the invention. FIG. 3 is a schematic front view illustrating an induction coil module according to a third embodiment of the present invention. In this embodiment, the fastening member 14 as shown in FIG. 2B is used to fix the coil 2 as shown in FIG. 1A. The fastening member 14 comprises a pressing part 141 and plural (e.g. four) engaging parts 142 for collectively fix the inner coil part 2a and the external coil part 2b. FIG. 4 is a schematic front view illustrating an induction coil module according to a fourth embodiment of the present invention. In this embodiment, the fastening member 14 comprises a pressing part 141 and two engaging parts 142 for fix the inner coil part 2a or the external coil part 2b.

In the above embodiments, the groove 113 comprises a first groove portion 113a and a second groove portion 113b in order to prevent the magnetic core assembly 117 from contacting with the coil that is placed on the first surface 111 of the supporting member 11. In a case that the magnetic core assembly 117 is disposed within the supporting member 11 or the magnetic core assembly 117 is not possibly contacted with the coil, the groove 113 may be designed as a continuous groove. Moreover, the fastening member is not restricted to that described in FIG. 1D or FIG. 2B. For example, the fastening member may include a single extension leg, and the width of the protruding block is greater than the width of the groove of the supporting member. In other words, any fastening member cooperating with the supporting member to clamp the coil can be used as the fastening member of the present invention.

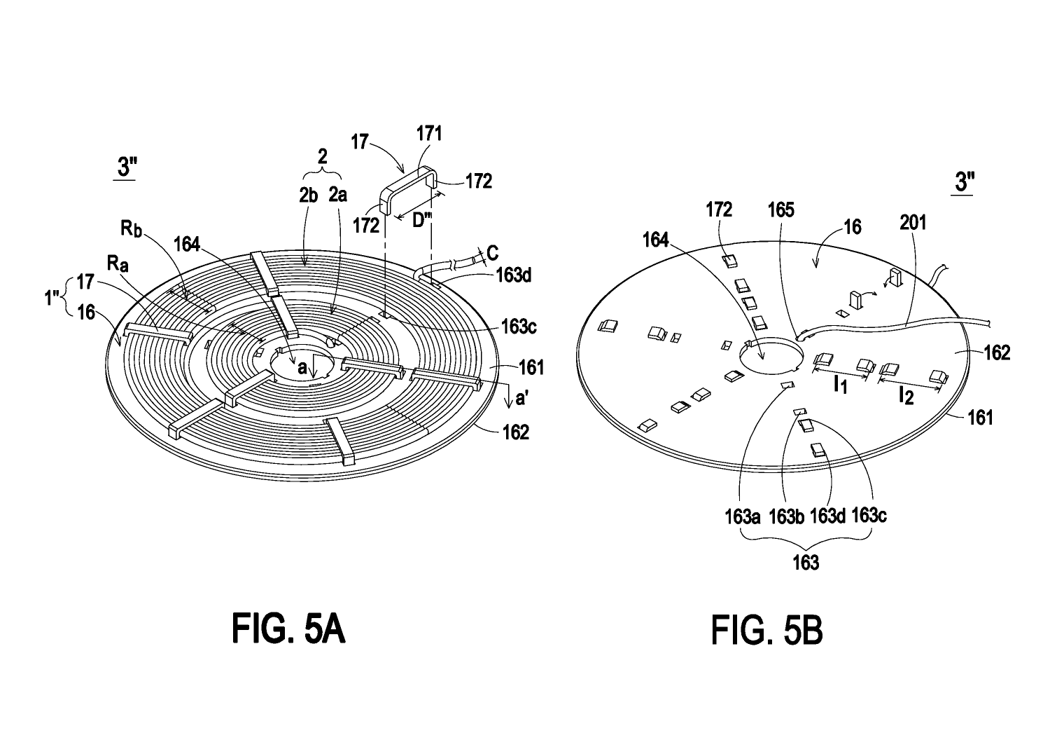

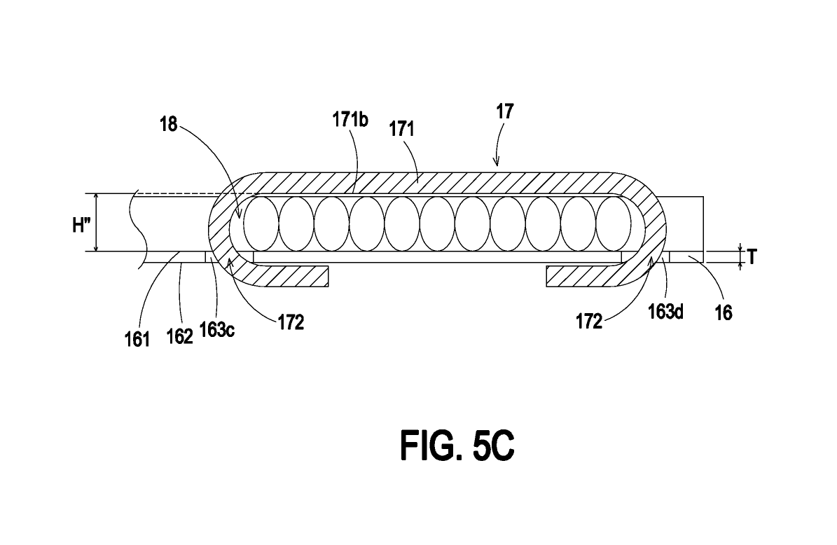

FIG. 5A is a schematic front view illustrating an induction coil module according to a fifth embodiment of the present invention. FIG. 5B is a schematic rear view illustrating the induction coil module of FIG. 5A. Please refer to FIGS. 5A and 5B. The induction coil module 3″ comprises a coil fixing module 1″ and a coil 2. The coil fixing module 1″ comprises a supporting member 16 and a fastening member 17. The coil 2 is supported on the supporting member 16. The fastening member 17 is disposed on the supporting member 16. By means of the supporting member 16 and the fastening member 17, the coil 2 is fixed with respect to the supporting member 16.

Please refer to FIGS. 5A and 5B again. In this embodiment, the supporting member 16 is a circular disk made of high temperature-resistant, insulated and nonmagnetic material (e.g. mica). The supporting member 16 has a thickness T (see FIG. 5C). The supporting member 16 has a first surface 161 and a second surface 162, wherein the first surface 161 and the second surface 162 are opposed to each other. In addition, the supporting member 16 further comprises at least a groove 163 and a middle opening 164. The groove 163 and the middle opening 164 run through the supporting member 16 in the direction perpendicular to the first surface 161 and the second surface 162. The middle opening 164 is substantially at a geometric center (e.g. a center of a circle) of the supporting member 16. In this embodiment, the supporting member 16 comprises plural grooves 163 (e.g. six grooves). In additions, the grooves 163 are radially arranged in the supporting member 16 and enclose the middle opening 164. The width of the groove 163 is substantially equal to the width of the coil 2. In this embodiment, the coil 2 comprises an inner coil part 2a and an external coil part 2b. The groove 163 comprises a first groove portion 163a, a second groove portion 163b, a third groove portion 163c and a fourth groove portion 163d, which are sequentially and radially arranged on in the supporting member 16. The distance I1 between the first groove portion 163a and the second groove portion 163b is equal to the width Ra of the inner coil part 2a. The distance I2 between the third groove portion 163c and the fourth groove portion 163d is equal to the width Rb of the external coil part 2b. The arrangement of the groove 163 may be varied according to the coil 2. The supporting member 16 further comprises a perforation 165. An output terminal 201 of the coil 2 is penetrated through the perforations 165.

In this embodiment, the fastening member 17 is made of high temperature-resistant, nonmagnetic and flexible material (e.g. an aluminum sheet sheathed by temperature-resistant silicone). For example, a process of fixing the external coil part 2b by the fastening member 17 will be illustrated. The length of the fastening member 17 is at least equal to the sum of the width Rb of the external coil part 2b, twice the wire diameter C of the external coil part 2b and twice the thickness T of the supporting member 16. The fastening member 17 comprises a pressing part 171 and an engaging part 172. The middle segment of the fastening member 17 is served as the pressing part 171, which has a length equal to or slightly smaller than the width Rb of the external coil part 2b. The end segments of the fastening member 17 are bent toward the pressing part 171 by a specified angle (e.g. 90 degrees), thereby defining two engaging parts 172. In this embodiment, the engaging parts 172 and the pressing part 171 are integrally formed. The length of the engaging part 172 is greater than the sum of the wire diameter C of the external coil part 2b and the thickness T of the supporting member 16. The engaging part spacing interval D″ between the two engaging parts 172 is equal to or slightly smaller than the width Rb of the external coil part 2b.

Please refer to FIGS. 5A and 5B again. The conductive wire 20 is continuously wound on the first surface 161 of the supporting member 16, thereby forming the coil 2. Then, the coil 2 is fixed by the fastening member 16. For fixing the external coil part 2b of the coil 2, the fastening member 17 is used for fixing the coil 2 into the third groove portion 163c and the fourth groove portion 163d. In this embodiment, the pressing part 171 of the fastening member 17 is substantially parallel with the first surface 161 of the supporting member 16. Since the length of the engaging part 172 is greater than the sum of the wire diameter C of the external coil part 2b and the thickness T of the supporting member 16, after the external coil part 2b is pressed by the pressing part 171, the two engaging parts 172 are respectively penetrated through the third groove portion 163c and the fourth groove portion 163d, and protruded over the second surface 162 of the supporting member 16. In response to a pressure applied on the engaging parts 172, the engaging parts 172 are attached on the second surface 162 of the supporting member 16. Meanwhile, the fastening member 17 is securely fixed on the supporting member 16 (see FIG. 5C).

After the fastening member 17 is assembled with the supporting member 16, a receptacle 18 is defined between the second sidewall 171b of the pressing part 171 and the first surface 161 of the supporting member 16. The height H″ of the receptacle 18 is substantially equal to the wire diameter C of the coil 2. As such, the second sidewall 171b of the pressing part 171 is in contact with the external coil part 2b to press the external coil part 2b, and the external coil part 2b lies flat on the first surface 161 of the supporting member 16. On the other hand, since the spacing interval D″ of the engaging part 172 is equal to or slightly smaller than the width Rb of the external coil part 2b, the movable range of the external coil part 2b in the direction parallel with the first surface 161 of the supporting member 16 is confined by the engaging part 172 of the fastening member 17. By means of the supporting member 16 and the fastening member 17, the external coil part 2b of the coil 2 is securely fixed on the supporting member 16. The process of fixing the inner coil part 2a of the coil 2 into the first groove portion 163a and the second groove portion 163b is similar to the process of fixing the external coil part 2b into the third groove portion 163c and the fourth groove portion 163d, and is not redundantly described herein.

In a case that the width of the coil 2 is changed, the location of the groove 163 of the supporting member 16 and the length of the fastening member 17 may be adjusted while achieving the purpose of fixing the coil 2 by the supporting member 16 and the fastening member 17.

From the above description, the coil fixing module of the present invention is capable of fixing the coil by means of a supporting member and a fastening member. After the engaging part of the fastening member is engaged with the supporting member, the coil is pressed by the second sidewall of the pressing part, so that the coil lies flat on the first surface of the supporting member. In addition, since the movable range of the coil part in the direction parallel with the first surface of the supporting member is confined by the engaging part of the fastening member, the coil is tightly wound on the supporting member. Since no adhesive is necessary to fix the coil by the coil fixing module of the present invention, the drawbacks of using the adhesive are overcome. Since the dispensing equipment and the drying machine are not necessary, the process of producing the induction coil module of the present invention is very cost-effective.

Moreover, after the conductive wire is wound as the coil, the coil is fixed by the supporting member and the fastening member without difficulty. In comparison with the prior art, the process of producing the induction coil module of the present invention is very simple. Moreover, due to the perforations of the supporting member, the inductance of the coil may be precisely adjusted according to the turn number of the coil.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A coil fixing module for fixing a coil of an electromagnetic device, said coil fixing module comprising:
a supporting member for supporting said coil; and
a fastening member disposed on said supporting member for clamping said coil between said supporting member and said fastening member, so that said coil is fixed with respect to said supporting member.

2. The coil fixing module according to claim 1 wherein said supporting member comprises a first surface and a second surface, said first surface and said second surface are opposed to each other, and said coil is supported on said first surface.

3. The coil fixing module according to claim 2 wherein said supporting member further comprises a groove, and said groove runs through said supporting member.

4. The coil fixing module according to claim 3 wherein said supporting member further comprises:
a middle opening running through said supporting member, wherein said groove is radially arranged in said supporting member and encloses said middle opening; and
at least one perforation running through said supporting member, wherein an output terminal of said coil is penetrated through said perforation.

5. The coil fixing module according to claim 4 wherein said supporting member further comprises a protruding edge, which is arranged near a periphery of said middle opening and slightly protruded over said first surface.

6. The coil fixing module according to claim 3 wherein said fastening member is aligned with said groove of said supporting member, said fastening member comprises a pressing part and an engaging part, said pressing part is substantially parallel with said first surface of said supporting member, and said engaging part is connected with said pressing part and partially accommodated within said groove for confining a movable range of said coil in a direction parallel with said first surface of said supporting member.

7. The coil fixing module according to claim 6 wherein said pressing part has a first sidewall and a second sidewall, which are opposed to each other, wherein said second sidewall is in contact with said coil.

8. The coil fixing module according to claim 7 wherein after said fastening member is assembled with said supporting member, a receptacle is defined by said second sidewall of said pressing part of said fastening member and said first surface of said supporting member, wherein a height of said receptacle is substantially equal to a wire diameter of said coil.

9. The coil fixing module according to claim 8 wherein said second sidewall of said pressing part of said fastening member has a saw-toothed profile for facilitating pressing said coil.

10. The coil fixing module according to claim 8 wherein said engaging part comprises at least one extension leg with a protruding block, and said protruding block is sustained against said second surface of said supporting member.

11. The coil fixing module according to claim 10 wherein said engaging part comprises two extension legs and connecting structure, said two extension legs are connected with each other through a connecting structure, and a gap is formed between said two extension legs.

12. The coil fixing module according to claim 11 wherein plural recesses are formed in said first sidewall of said pressing part, and said connecting structure of said engaging part is accommodated within said recess, so that said engaging part is fixed with respect to said pressing part.

13. The coil fixing module according to claim 12 wherein said recesses are discretely arranged in said first sidewall of said pressing part at regular spacing intervals, and a width of each recess is substantially equal to a wire diameter of said coil.

14. The coil fixing module according to claim 6 wherein said pressing part and said engaging part of said fastening member are integrally formed.

15. The coil fixing module according to claim 6 wherein said fastening member is made of a flexible material, and an end of said fastening member is bent to define said engaging part.

16. The coil fixing module according to claim 15 wherein said engaging part is penetrated through said groove, protruded over said second surface of said supporting member, and sustained against said second surface of said supporting member.

17. The coil fixing module according to claim 1 wherein a magnetic core assembly of said electromagnetic device is further disposed on said supporting member.

18. The coil fixing module according to claim 1 wherein said supporting member and said fastening member are made of high temperature-resistant material.

19. The coil fixing module according to claim 1 wherein said electromagnetic device is an induction cooking stove.

20. An induction coil module of an electromagnetic device, said induction coil module comprising:
a supporting member having a first surface and a second surface;
a coil supported on said first surface of said supporting member;
a fastening member for fixing said coil on said first surface of said supporting member; and
a magnetic core assembly disposed on said second surface of said supporting member.
